(19) United States
(12) Patent Application Publication
(10) Pub. No.: US 2012/0149359 A1
(43) Pub. Date: Jun. 14, 2012

(54) WIRELESS REMOTE CONTROL DEVICE USING MOBILE PHONE

(76) Inventor: JUN-SHENG HUANG, Shenzhen City (CN)

(21) Appl. No.: 12/963,637

(22) Filed: Dec. 9, 2010

(51) Int. Cl. H04M 3/00

(52) U.S. Cl. 455/420

(57) ABSTRACT

A wireless remote control device is provided using a mobile phone. The mobile phone's keys, touch-sensitive screen, gravity sensor, or audio controller are signal triggering means to issue instructions. A processing software is installed in the mobile phone and the instructions are processed by the processing software, delivered to a communication module via the mobile phone's port, and radiated to the remote controlled toy by the communication module, so as to control the remote controlled toy's mechanical actions and audio/lighting effects. The wireless remote control device is intelligent, functionally versatile, easily extensible, and hot pluggable. In addition, infrared transmitter is adopted that not only is accurate and robust to interference, but also produces little interference itself to the environment and the neighboring devices.

### (A) TECHNICAL FIELD OF THE INVENTION

The present invention generally relates to wireless remote control devices, and more particular to a wireless remote control device by installing a communication module and a processing software on a mobile phone.

### (B) DESCRIPTION OF THE PRIOR ART

Wireless remote control toys usually employ a hand-held wireless signal transmission device to transmit various instructions triggered by various buttons on the wireless signal transmission device. On the other hand, the toy to be controlled, within a specific distance, is able to receive the instructions, conduct data processing, issues various corresponding commands to control the toy's electrical and mechanical mechanisms so that the toy performs various actions, such as walking, turning, climbing, etc. accordingly. For this kind of toys, there are usually a wireless remote control handle, power battery, wireless reception module, driving circuit, driving mechanism, and the toy itself. For the wireless remote control handle, there are buttons for triggering the transmission of various instructions. The instructions are modulated onto a radio signal and then the radio signal is transmitted through an antenna. Within a specific distance, the toy receives the radio signal through its wireless reception circuit, retrieves the instructions by demodulating the radio signal, produces various electrical commands for the driving circuit and for the provision of electrical power, so that the toy conducts operations corresponding to the received instructions. This kind of toys requires a dedicated wireless remote control handle, which contributes to a higher production effort and cost.

### SUMMARY OF THE INVENTION

The objective of the present invention is to provide a wireless remote control device by using a mobile phone so as to achieve versatile control, low cost, and flexible extension.

The wireless remote control device contains a mobile phone, and a communication module installed on a port of the mobile phone. The mobile phone has a signal triggering means and a processing software which communicates with the communication module.

In a first embodiment, the signal triggering means is a number of keys of the mobile phone.

In a second embodiment, the signal triggering means is a touch-sensitive screen of the mobile phone.

In a third embodiment, the signal triggering means is a gravity sensor of the mobile phone.

In a fourth embodiment, the signal triggering means is a voice-activated audio controller of the mobile phone.

In one embodiment, the communication module contains a signal processor and a signal transmitter connected to the signal processor.

In one embodiment, the signal transmitter is an infrared signal transmitter.

The touch-sensitive screen has a number of function icons for a page selection key, a help key, a throttle control key, a wheel central key, a forward key, a backward key, a turning-left key, a turning-right key, a left-right fine-tuning key, a channel selection key, a left-right sensitivity key, a forward-backward speed control key, and a fire key.

The advantages of the present invention are as follows. A user is able to use a mobile phone's keys, touch-sensitive screen, gravity sensor, or audio controller to issue instructions, and the instructions are processed by the processing software, delivered to the communication module via the mobile phone's port, and radiated to the remote controlled toy by the communication module, so as to control the remote controlled toy's mechanical actions and audio/lighting effects. As such, each remote controlled toy does not require its own dedicated remote controller. A mobile phone with the communication module and the processing software installed could be used as well. Therefore, the remote controlled toys could be produced with less cost and, as the mobile phone is more intelligent, the remote controlled toy could be controlled in various manners and its function could be easily extended. In addition, infrared not only is accurate and robust to interference, but also produces little interference itself to the environment and the neighboring devices.

The foregoing objectives and summary provide only a brief introduction to the present invention. To fully appreciate these and other objects of the present invention as well as the invention itself', all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a remote control device using mobile phone according a first embodiment of the present invention.

FIG. 2 is a schematic diagram showing a remote control device using mobile phone according a second embodiment of the present invention.

FIG. 3 is a schematic diagram showing a remote control device using mobile phone according a third embodiment of the present invention.

FIG. 4 is a schematic diagram showing the functional blocks of a remote control device using mobile phone according to the present invention.

FIG. 5 is a schematic diagram showing the functional blocks of a remote controlled toy according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

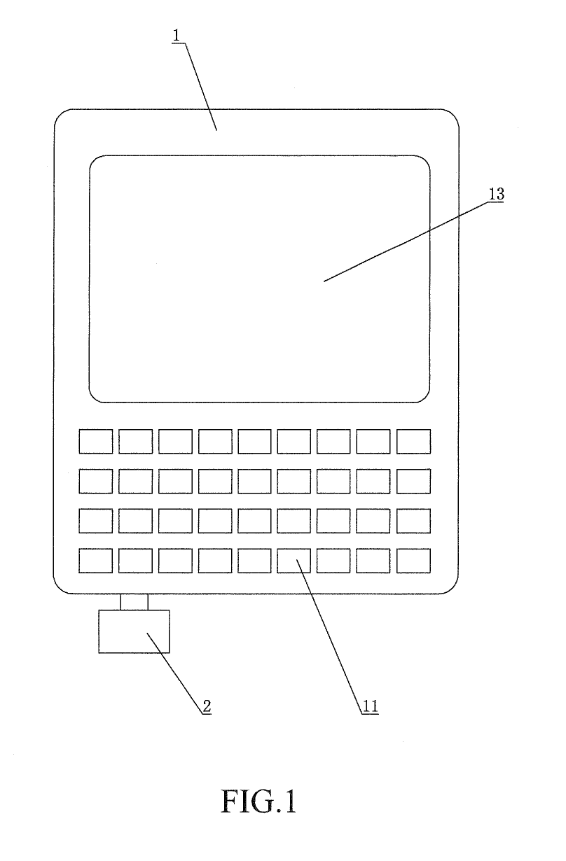

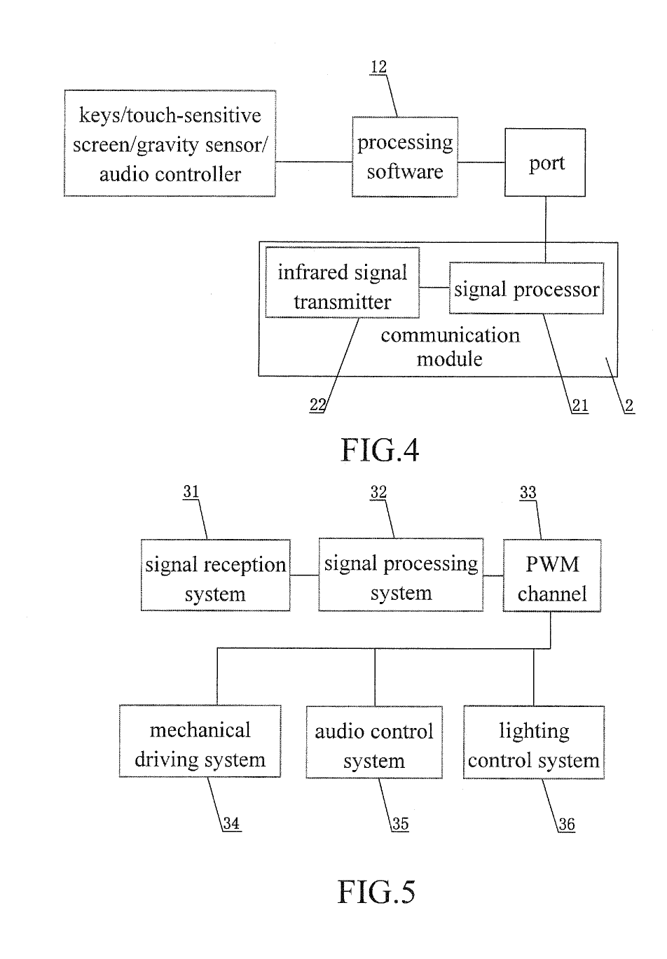

As shown in FIGS. 1, 4, and 5, a remote control device using mobile phone according to a first embodiment of the present invention contains a mobile phone 1, and a communication module 2 installed on a port of the mobile phone 1. The mobile phone 1 has a number of keys 11, and installed with a processing software 12 for receiving signals triggered by the keys 11, processing the signals, and delivering the processed signals to the communication module 2 through the port. The communication module 2 contains a signal processor 21 and an infrared signal transmitter 22. The signal processor 21 receives the signals from the processing software, processes the signals, and delivers the processed signals to the infrared signal transmitter 22, which in turn radiates the signals to a remote controlled toy for it to perform mechanical actions and to produce audio and lighting effects.

As shown in FIG. 5, the remote controlled toy contains a signal reception system 31, a signal processing system 32, a PWM channel 33, a mechanical driving system 34, an audio control system 35, and a lighting control system 36. When the remote controlled toy receives radio signals from the communication module 2 by the signal reception system 31, the signals are processed by the signal processing system 32. The mechanical driving system 34, the audio control system 35, and the lighting control system 36 are then controlled through the PWM channel 33 by the signal processing system 32.

As described above, a user is able to use a mobile phone's keys to issue instructions, and the instructions are processed by the processing software, delivered to the communication module via the mobile phone's port, and radiated to the remote controlled toy by the communication module, so as to control the remote controlled toy's mechanical actions and audio/lighting effects. As such, each remote controlled toy does not require its own dedicated remote controller. A mobile phone with the communication module and the processing software installed could be used as well. Therefore, the remote controlled toys could be produced with less cost and, as the mobile phone is more intelligent, the remote controlled toy could be controlled in various manners and its function could be easily extended. In addition, infrared not only is accurate and robust to interference, but also produces little interference itself to the environment and the neighboring devices.

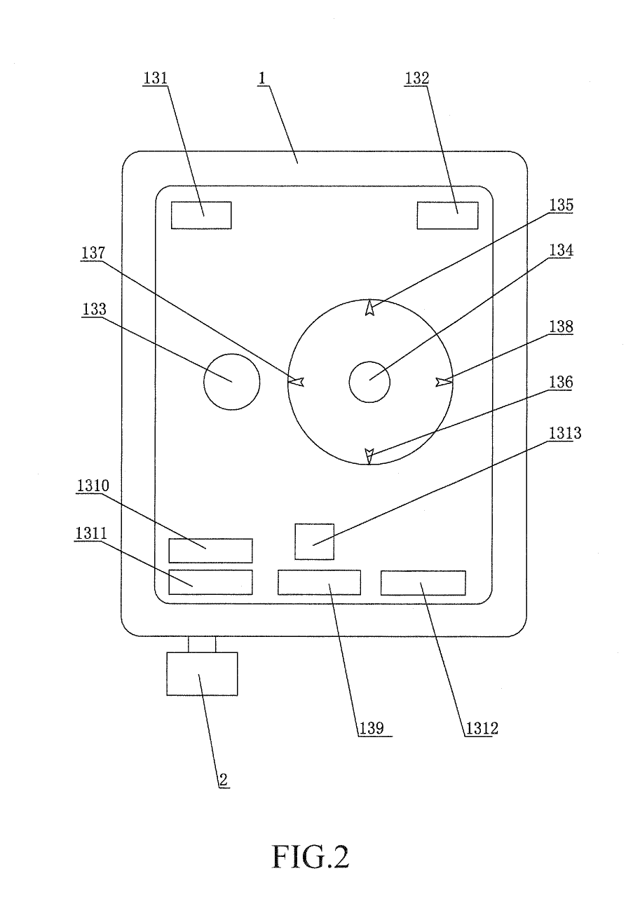

As shown in FIGS. 2, 4, and 5, a remote control device using mobile phone according to a second embodiment of the present invention contains a mobile phone 1, and a communication module 2 installed on a port of the mobile phone 1. The mobile phone 1 has a touch-sensitive screen 13 with function icons: a page selection key 131, a help key 132, a throttle control key 133, a wheel central key 134, a forward key 135, a backward key 136, a turning-left key 137, a turning-right key 138, a left-right fine-tuning key 139, a channel selection key 1310, a left-right sensitivity key 1311, a forward-backward speed control key 1312, and a fire key 1313. The mobile phone 1 is installed with a processing software 12 for receiving signals triggered by the keys on the touch-sensitive screen 13, processing the signals, and delivering the processed signals to the communication module 2 through the port. The communication module 2 contains a signal processor 21 and an infrared signal transmitter 22. The signal processor 21 receives the signals from the processing software, processes the signals, and delivers the processed signals to the infrared signal transmitter 22, which in turn radiates the signals to a remote controlled toy for it to perform mechanical actions and to produce audio and lighting effects.

As shown in FIG. 5, the remote controlled toy contains a signal reception system 31, a signal processing system 32, a PWM channel 33, a mechanical driving system 34, an audio control system 35, and a lighting control system 36. When the remote controlled toy receives radio signals from the communication module 2 by the signal reception system 31, the signals are processed by the signal processing system 32. The mechanical driving system 34, the audio control system 35, and the lighting control system 36 are then controlled through the PWM channel 33 by the signal processing system 32.

As described above, a user is able to use a mobile phone's touch-sensitive screen to issue instructions, and the instructions are processed by the processing software, delivered to the communication module via the mobile phone's port, and radiated to the remote controlled toy by the communication module, so as to control the remote controlled toy's mechanical actions and audio/lighting effects. As such, each remote controlled toy does not require its own dedicated remote controller. A mobile phone with the communication module and the processing software installed could be used as well. Therefore, the remote controlled toys could be produced with less cost and, as the mobile phone is more intelligent, the remote controlled toy could be controlled in various manners and its function could be easily extended. In addition, infrared not only is accurate and robust to interference, but also produces little interference itself to the environment and the neighboring devices.

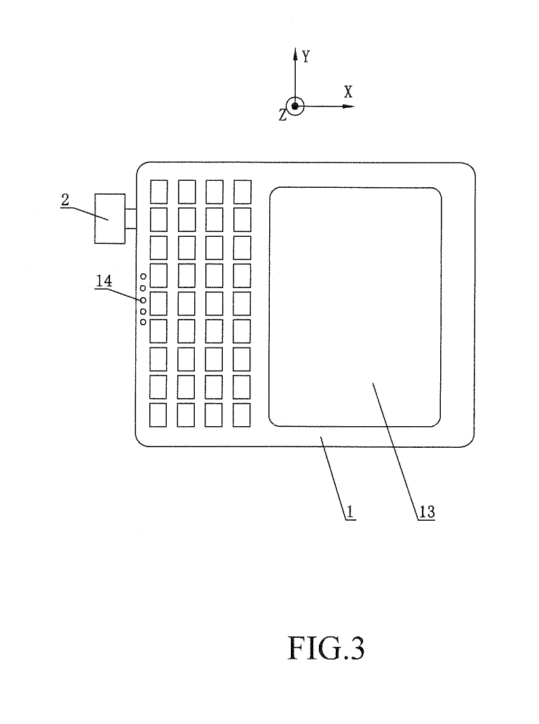

As shown in FIGS. 3, 4, and 5, a remote control device using mobile phone according to a third embodiment of the present invention contains a mobile phone 1, and a communication module 2 installed on a port of the mobile phone 1. The mobile phone 1 has a gravity sensor that, as shown in FIG. 3, using the Y axis is the axle, tilting to the left means turning left, and tilting to the right means turning right. Similarly, using the X is the axle, tilting forward means moving ahead, and tilting backward means moving back; and, using the Z axis as axle, shifting left means moving forward and turning left, and shifting right means moving forward and turning right.

The mobile phone 1 is installed with a processing software 12 for receiving signals triggered by the gravity sensor, processing the signals, and delivering the processed signals to the communication module 2 through the port. The communication module 2 contains a signal processor 21 and an infrared signal transmitter 22. The signal processor 21 receives the signals from the processing software, processes the signals, and delivers the processed signals to the infrared signal transmitter 22, which in turn radiates the signals to a remote controlled toy for it to perform mechanical actions and to produce audio and lighting effects.

As shown in FIG. 5, the remote controlled toy contains a signal reception system 31, a signal processing system 32, a PWM channel 33, a mechanical driving system 34, an audio control system 35, and a lighting control system 36. When the remote controlled toy receives radio signals from the communication module 2 by the signal reception system 31, the signals are processed by the signal processing system 32. The mechanical driving system 34, the audio control system 35, and the lighting control system 36 are then controlled through the PWM channel 33 by the signal processing system 32.

As described above, a user is able to use a mobile phone's gravity sensor to issue instructions, and the instructions are processed by the processing software, delivered to the communication module via the mobile phone's port, and radiated to the remote controlled toy by the communication module, so as to control the remote controlled toy's mechanical actions and audio/lighting effects. As such, each remote controlled toy does not require its own dedicated remote controller. A mobile phone with the communication module and the processing software installed could be used as well. Therefore, the remote controlled toys could be produced with less cost and, as the mobile phone is more intelligent, the remote controlled toy could be controlled in various manners and its function could be easily extended. In addition, infrared not only is accurate and robust to interference, but also produces little interference itself to the environment and the neighboring devices.

As shown in FIGS. 3, 4, and 5, a remote control device using mobile phone according to a fourth embodiment of the present invention contains a mobile phone 1, and a communication module 2 installed on a port of the mobile phone 1. The mobile phone 1 has an audio controller for voice activation that, as shown in FIG. 3, a user utters verbal instructions to an audio receiver 14 on the mobile phone 1 and the verbal instructions are recognized by the audio controller into corresponding signals for the remote-controlled toy (e.g., “forward” means “moving ahead,” and “backward” means “moving back”, etc.)

The mobile phone 1 is installed with a processing software 12 for receiving signals triggered by the voice-activated audio controller, processing the signals, and delivering the processed signals to the communication module 2 through the port. The communication module 2 contains a signal processor 21 and an infrared signal transmitter 22. The signal processor 21 receives the signals from the processing software, processes the signals, and delivers the processed signals to the infrared signal transmitter 22, which in turn radiates the signals to a remote controlled toy for it to perform mechanical actions and to produce audio and lighting effects.

As shown in FIG. 5, the remote controlled toy contains a signal reception system 31, a signal processing system 32, a PWM channel 33, a mechanical driving system 34, an audio control system 35, and a lighting control system 36. When the remote controlled toy receives radio signals from the communication module 2 by the signal reception system 31, the signals are processed by the signal processing system 32. The mechanical driving system 34, the audio control system 35, and the lighting control system 36 are then controlled through the PWM channel 33 by the signal processing system 32.

As described above, a user is able to use a mobile phone's audio controller to issue instructions, and the instructions are processed by the processing software, delivered to the communication module via the mobile phone's port, and radiated to the remote controlled toy by the communication module, so as to control the remote controlled toy's mechanical actions and audio/lighting effects. As such each remote controlled toy does not require its own dedicated remote controller. A mobile phone with the communication module and the processing software installed could be used as well. Therefore, the remote controlled toys could be produced with less cost and, as the mobile phone is more intelligent, the remote controlled toy could be controlled in various manners and its function could be easily extended. In addition, infrared not only is accurate and robust to interference, but also produces little interference itself to the environment and the neighboring devices.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A wireless remote control device, comprising:
a mobile phone having a port and a signal triggering means;
a communication module installed on said port of said mobile phone; and
a processing software installed in said mobile phone;
wherein said processing software receives instructions from said signal triggering means, and communicates with said communication module.

2. The wireless remote control device according to claim 1, wherein said signal triggering means is a plurality of keys of said mobile phone.

3. The wireless remote control device according to claim 1, wherein said signal triggering means is a touch-sensitive screen of said mobile phone.

4. The wireless remote control device according to claim 1, wherein said signal triggering means is a gravity sensor of said mobile phone.

5. The wireless remote control device according to claim 1, wherein said signal triggering means is a voice-activated audio controller of said mobile phone.

6. The wireless remote control device according to claim 1, wherein said communication module contains a signal processing and a signal transmitter connected to said signal processor.

7. The wireless remote control device according to claim 3, wherein said touch-sensitive screen has a plurality of function icons for, respectively, a page selection key, a help key, a throttle control key, a wheel central key, a forward key, a backward key, a turning-left key, a turning-right key, a left-right fine-tuning key, a channel selection key, a left-right sensitivity key, a forward-backward speed control key, and a fire key.

8. The wireless remote control device according to claim 6, wherein said signal transmitter is an infrared signal transmitter.

9. The wireless remote control device according to claim 6, wherein said communication module is hot-pluggable to said port.
